(19) United States
(12) Patent Application Publication
(10) Pub. No.: US 2024/0274915 A1
(43) Pub. Date: Aug. 15, 2024

(54) METHOD FOR RECYCLING LITHIUM-ION SECONDARY BATTERY

(71) Applicant: NGK INSULATORS, LTD., Nagoya-City (JP)

(72) Inventors: Yuki TANAKA, Nagoya-City (JP); Nobuyuki KOBAYASHI, Nagoya-City (JP)

(73) Assignee: NGK INSULATORS, LTD., Nagoya-City (JP)

(21) Appl. No.: 18/646,910

(22) Filed: Apr. 26, 2024

Related U.S. Application Data
(63) Continuation of application No. PCT/JP2022/044428, filed on Dec. 1, 2022.

(30) Foreign Application Priority Data
Dec. 23, 2021 (JP) 2021-210001

(51) Int. Cl. H01M 10/54; H01M 4/02; H01M 4/485; H01M 4/525; H01M 10/0525; H01M 10/058; H01M 50/434

(52) U.S. Cl. CPC H01M 10/54; H01M 4/485; H01M 4/525; H01M 10/0525; H01M 10/058; H01M 50/434; H01M 2004/027; H01M 2004/028

(57) ABSTRACT

Provided is a method for recycling a lithium-ion secondary battery, which includes: providing a used lithium-ion secondary battery that includes: (i) a battery element including a positive electrode, a separator, and a negative electrode, wherein at least one of the positive electrode and the negative electrode is a ceramic electrode; (ii) an electrolytic solution; and (iii) a battery container accommodating the battery element and the electrolytic solution; taking out the ceramic electrode from the lithium-ion secondary battery so that the positive electrode and the negative electrode are separated from each other, provided that the separator may be bonded to the ceramic electrode taken out; subjecting the ceramic electrode taken out to an electrode restoration treatment including cleaning and/or heat treatment; and putting the ceramic electrode subjected to the electrode restoration treatment back into the battery container to assemble a lithium-ion secondary battery.

### CROSS-REFERENCE TO RELATED APPLICATIONS

This application is a continuation application of PCT/JP2022/044428 filed Dec. 1, 2022, which claims priority to Japanese Patent Application No. 2021-210001 filed Dec. 23, 2021, the entire contents all of which are incorporated herein by reference.

### BACKGROUND OF THE INVENTION

### 1. Field of the Invention

The present invention relates to a method for recycling a lithium-ion secondary battery.

### 2. Description of the Related Art

Various methods have been proposed for recycling lithium-ion secondary batteries or their components. For example, Patent Literature 1 (JP2014-127417A) discloses a method for recycling a negative electrode active material layer and has proposed that a negative electrode having a negative electrode active material layer containing a non-aqueous binder and a current collector is immersed in an aqueous solution, the separated negative electrode active material layer is recovered, and the recovered negative electrode active material layer is attached again to the current collector. Patent Literature 2 (JP2019-145315A) discloses a method for recycling a lithium-ion secondary battery, comprising injecting dry air into a used lithium-ion secondary battery containing a non-aqueous electrolyte. Patent Literature 3 (JP5077788B) discloses a method for recovering cobalt and lithium from a battery material and has proposed that the electrode material is dissolved in sulfuric acid to form a solution in which cobalt ions and lithium ions are dissolved, and this solution is separated from the insoluble matter. Patent Literature 4 (JP5664043B) discloses a method for recycling a waste lithium ion battery electrolytic solution, comprising recovering an electrolytic solution from a waste lithium ion battery and using the electrolytic solution as fuel. Patent Literature 5 (JP2014-82120A) discloses a system for determining whether a non-aqueous electrolyte secondary battery is suitable for reuse, comprising a first acquisition unit that acquires a first measurement value obtained by measuring the amount of lithium fluoride coating formed on the positive electrode, a first storage unit that stores a previously obtained first range of the lithium fluoride coating formed on the positive electrode, and a first determination unit that determines whether the target battery is suitable for recycling based on the first measurement value and the first range.

Meanwhile, in many existing lithium-ion secondary batteries, a powder-dispersed positive electrode (so-called coated electrode) produced by applying and drying a positive electrode mixture containing a positive electrode active material, a conductive additive, a binder, or the like is adopted.

In general, a powder-dispersed positive electrode contains a relatively large amount (e.g., about 10 wt %) of components (such as binders and conductive additives) that do not contribute to the capacity and thus has a low packing density of the lithium complex oxide as the positive electrode active material. Accordingly, the powder-dispersed positive electrode should be greatly improved from the viewpoint of the capacity and charge/discharge efficiency. Some attempts have been made to improve the capacity and charge/discharge efficiency by positive electrodes or layers of positive electrode active material composed of lithium complex oxide sintered plate. In this case, since the positive electrode or the positive electrode active material layer does not contain binders or conductive additives (e.g., conductive carbons), it is expected to have high capacity and good charge/discharge efficiency due to high packing density of the lithium complex oxide. For example, Patent Literature 6 (JP6374634B) discloses a lithium complex oxide sintered plate such as lithium cobaltate LiCoO₂ (which will be hereinafter referred to as LCO) that is used for a positive electrode of a lithium-ion secondary battery. This lithium complex oxide sintered plate has a structure in which a plurality of primary grains having a layered rock salt structure are bonded and a porosity of 3 to 40%, a mean pore diameter of 15 μm or less, an open pore rate of 70% or more, a thickness of 15 to 200 μm, and a primary grain size that is the average grain size of the plurality of primary grains of 20 μm or less. In addition, the lithium complex oxide sintered plate has an average of the angles defined by the (003) planes of the plurality of primary grains and the plate face of the lithium complex oxide sintered plate, that is, a mean tilt angle of more than 0° to 30° or less.

Meanwhile, use of a titanium-containing sintered plate as a negative electrode has been also proposed. For example, Patent Literature 7 (JP6392493B) discloses a sintered plate of lithium titanate Li₄Ti₅O₁₂ (which will be hereinafter referred to as LTO) used for a negative electrode of a lithium-ion secondary battery. The LTO sintered plate has a structure in which a plurality of primary grains are bonded and a thickness of 10 to 290 μm, a primary grain size that is the average grain size of the plurality of primary grains of 1.2 μm or less, a porosity of 21 to 45%, and an open pore rate of 60% or more.

### CITATION LIST

### Patent Literature

Patent Literature 1: JP2014-127417A
Patent Literature 2: JP2019-145315A
Patent Literature 3: JP5077788B
Patent Literature 4: JP5664043B
Patent Literature 5: JP2014-82120A
Patent Literature 6: JP6374634B
Patent Literature 7: JP6392493B

### SUMMARY OF THE INVENTION

Recycling of the lithium-ion secondary batteries or their components as described above is roughly divided into re-cycling (resource recovery) and re-use (reuse). Re-cycling of batteries involves recovery of materials such as electrodes as active materials or alloys, but the cost is high due to complicated processes. Meanwhile, regarding re-use of batteries, batteries are reused by evaluating the performance of the batteries and sorting them into different applications according to the degree of deterioration. For example, if the degree of deterioration is small, it can be reused for electric vehicles (EV) and forklifts, and if the degree of deterioration is large, it can be reused for backup power supply applications.

As described above, the process of re-cycling lithium ion secondary batteries is complicated and the cost is high, while the applications of re-use are limited. For this reason, the current situation is that the recycling of lithium ion secondary batteries or their components has hardly progressed. In particular, since conventional lithium-ion secondary batteries that contain an electrode containing an organic binder or a conductive additive have many deterioration factors, it has been difficult to separate and regenerate the used electrode for recycling.

The inventors have now found that by subjecting a ceramic electrode taken out from a used lithium-ion secondary battery to cleaning and/or heat treatment, it is possible to reassemble a lithium-ion secondary battery whose performance has been sufficiently restored with simple procedure at low cost.

Accordingly, an object of the present invention is to provide a method for recycling a lithium-ion secondary battery, which employs a used lithium-ion secondary battery and makes it possible to reassemble a lithium-ion secondary battery whose performance is sufficiently restored with simple procedure at low cost.

The present invention provides the following aspects.

### [Aspect 1]

A method for recycling a lithium-ion secondary battery, comprising:
providing a used lithium-ion secondary battery that comprises: (i) a battery element including a positive electrode, a separator, and a negative electrode, wherein at least one of the positive electrode and the negative electrode is a ceramic electrode; (ii) an electrolytic solution; and (iii) a battery container accommodating the battery element and the electrolytic solution;
taking out the ceramic electrode from the lithium-ion secondary battery so that the positive electrode and the negative electrode are separated from each other, provided that the separator may be bonded to the ceramic electrode taken out;
subjecting the ceramic electrode taken out to an electrode restoration treatment including cleaning and/or heat treatment; and
putting the ceramic electrode subjected to the electrode restoration treatment back into the battery container to assemble a lithium-ion secondary battery.

### [Aspect 2]

The method for recycling a lithium-ion secondary battery according to aspect 1, wherein the electrode restoration treatment comprises cleaning the ceramic electrode with a polar solvent to remove impurities contained in and/or adhering to the ceramic electrode, followed by drying.

### [Aspect 3]

The method for recycling a lithium-ion secondary battery according to aspect 1 or 2, wherein the ceramic electrode further comprises a positive electrode current collector and/or a negative electrode current collector, wherein the positive electrode current collector and/or the negative electrode current collector is detached before and/or during the cleaning, and wherein the positive electrode current collector and/or the negative electrode current collector is attached to the ceramic electrode after the electrode restoration treatment.

### [Aspect 4]

The method for recycling a lithium-ion secondary battery according to aspect 2 or 3, wherein the electrode restoration treatment comprises heating, at 300 to 1000° C., the ceramic electrode that have cleaned and dried.

### [Aspect 5]

The method for recycling a lithium-ion secondary battery according to aspect 4, wherein the electrode restoration treatment comprises degreasing the ceramic electrode at 300 to 600° C. and/or firing the ceramic electrode at 650 to 1000° C.

### [Aspect 6]

The method for recycling a lithium-ion secondary battery according to any one of aspects 1 to 5, wherein the positive electrode is a ceramic positive electrode, and the ceramic positive electrode is composed of a lithium complex oxide sintered body.

### [Aspect 7]

The method for recycling a lithium-ion secondary battery according to any one of aspects 1 to 6, wherein the positive electrode is a ceramic positive electrode, and the ceramic positive electrode is an oriented positive electrode containing a plurality of primary grains composed of a lithium complex oxide, the plurality of primary grains being oriented at an average orientation angle of over 0° and 30° or less with respect to a principal plane of the positive electrode.

### [Aspect 8]

The method for recycling a lithium-ion secondary battery according to aspect 6 or 7, wherein the lithium complex oxide is lithium cobaltate.

### [Aspect 9]

The method for recycling a lithium-ion secondary battery according to any one of aspects 1 to 8, wherein the negative electrode is a ceramic negative electrode, and the ceramic negative electrode is composed of a titanium-containing sintered body.

### [Aspect 10]

The method for recycling a lithium-ion secondary battery according to aspect 9, wherein the titanium-containing sintered body contains lithium titanate or niobium titanium complex oxide.

### [Aspect 11]

The method for recycling a lithium-ion secondary battery according to any one of aspects 1 to 10, wherein the separator is a ceramic separator, and the ceramic separator comprises at least one selected from the group consisting of MgO, Al₂O₃, ZrO₂, SiC, Si₃N₄, AlN, and cordierite.

### [Aspect 12]

The method for recycling a lithium-ion secondary battery according to any one of aspects 1 to 11, further comprising replacing the electrolytic solution in the lithium-ion secondary battery with a fresh electrolytic solution.

### [Aspect 13]

The method for recycling a lithium-ion secondary battery according to any one of aspects 1 to 12, further comprising replacing the battery container with another battery container after the ceramic electrode is taken out and before the ceramic electrode is put back into the battery container.

### [Aspect 14]

The method for recycling a lithium-ion secondary battery according to any one of aspects 1 to 13, further comprising, when or before the lithium-ion secondary battery is assembled, replacing the positive electrode or negative electrode other than the ceramic electrode subjected to the electrode restoration treatment with a new or comparable positive electrode or negative electrode.

### BRIEF DESCRIPTION OF THE DRAWINGS

FIG. 1 is a schematic sectional view of an example of the lithium-ion secondary battery to be used in the method of the present invention.

FIG. 2 is a SEM image showing an example of a cross section perpendicular to the layer face of an oriented positive electrode layer.

FIG. 3 is an EBSD image in the cross section of the oriented positive electrode layer shown in FIG. 2.

FIG. 4 is an area-based histogram showing the distribution of orientation angles of primary grains in the EBSD image shown in FIG. 3.

FIG. 5 is a schematic perspective view showing an example of a honeycomb-type ceramic positive electrode.

FIG. 6A is a schematic perspective view conceptually showing the configuration of a lithium-ion secondary battery comprising a honeycomb-type ceramic positive electrode.

FIG. 6B is a cross-sectional view along the 6B-6B line of the lithium-ion secondary battery shown in FIG. 6A.

### DETAILED DESCRIPTION OF THE INVENTION

### Method for Recycling Lithium-Ion Secondary Battery

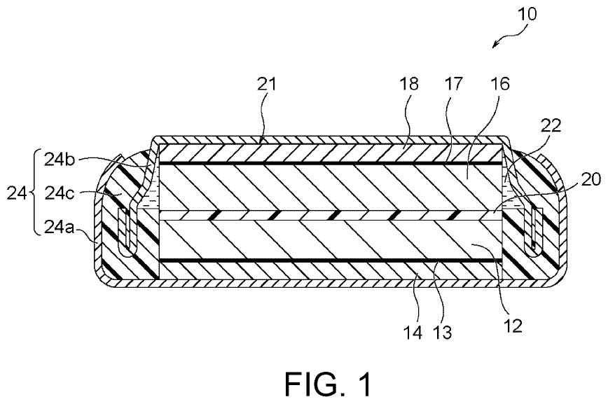

The used lithium-ion secondary battery to be used in the method of the present invention is a sintered body-type battery (semi-solid battery) comprising a ceramic electrode together with an electrolytic solution. FIG. 1 schematically shows an example of such a lithium-ion secondary battery. The lithium-ion secondary battery 10 shown in FIG. 1 is a coin-shaped battery, but the present invention is not limited to this example, and batteries in other forms such as button batteries, cylindrical batteries, prismatic batteries, pack batteries, car batteries, and sheet batteries may be used.

That is, in the method for recycling a lithium-ion secondary battery according to the present invention, the used lithium-ion secondary battery 10 comprising a battery element 21, an electrolytic solution 22, and a battery container 24 accommodating the battery element 21 and the electrolytic solution 22 is first prepared. The battery element 21 includes a positive electrode 12, a separator 20, and a negative electrode 16, wherein at least one of the positive electrode 12 and the negative electrode 16 is a ceramic electrode. Then, the ceramic electrode (that is, the positive electrode 12 and/or the negative electrode 16) is taken out from the lithium-ion secondary battery 10 so that the positive electrode 12 and the negative electrode 16 are separated from each other. At this time, the separator 20 may be bonded to the ceramic electrode taken out. Then, the ceramic electrode taken out is subjected to electrode restoration treatment including cleaning and/or heat treatment. Finally, the ceramic electrode subjected to the electrode restoration treatment is put back into the battery container 24, to assemble the lithium-ion secondary battery 10. In this way, by subjecting the ceramic electrode (that is, the positive electrode 12 and/or the negative electrode 16) taken out from the used lithium-ion secondary battery 10 to cleaning and/or heat treatment, it is possible to reassemble a lithium-ion secondary battery 10 whose performance has been sufficiently restored with simple procedure at low cost.

As has been mentioned above, re-cycling of lithium-ion secondary batteries is complicated and expensive, while re-use has limited applications. For this reason, the current situation is that the recycling of lithium ion secondary batteries or their components has hardly progressed. In particular, since conventional lithium-ion secondary batteries that contain an electrode containing an organic binder or a conductive additive have many deterioration factors, it has been difficult to separate and regenerate the used electrode for recycling. This problem is advantageously overcome by the present invention. This is explained as follows.

First, various factors are conceivable as general deterioration factors of conventional lithium-ion secondary batteries. First, at the time of manufacturing the battery or at the initial stage of use, a carbonic acid layer or a fluorinated layer is generated, and a gas is generated on the electrode surface due to the reaction between the water contained in the electrolyte and the electrolyte anion PF₅⁻, the reaction between PF₅ or HF generated due to the aforementioned reaction and a solvent, the reaction between the electrolyte and an active material, or the side reaction thereof. Thereafter, the use of the battery causes deterioration and reduction of the active material itself used in the active material layer of the electrode. Due to repeated charging and discharging, cracking of grains due to changes in swelling and contraction of grains, structural deterioration and destruction due to phase change and strain, dissolution of the positive electrode active material, deposition of the dissolved material on the negative electrode, a short circuit between the positive electrode and the negative electrode due to this, depletion of lithium ions, formation of Li dendrites at the negative electrode due to low temperature operation/high current operation, a decrease in lithium ions and a short circuit between the positive electrode and the negative electrode due to this, and deterioration of the interface are induced. In addition, corrosion of the surface of the current collector, separation of the active material from the current collector, deterioration of the conductivity of the electrode, change and unevenness of the conductive network in the active material layer, deterioration of the binder, and clogging of the separator occur, and the internal resistance of the cell is increased by these changes. In addition, depending on the usage conditions, various factors can be mentioned as causes of capacity deterioration such as a decrease in reaction amount of the active material due to overcharge or overdischarge, deterioration due to oxidation and reduction reactions of the electrolyte, deterioration of the reaction interface layer, and deterioration due to expansion and contraction of the electrode during charging and discharging.

In contrast, the used lithium-ion secondary battery to be used in the present invention is a sintered body-type battery comprising the battery element in which at least one of the positive electrode and the negative electrode is a ceramic electrode, together with the electrolytic solution, and has fewer deterioration factors than general lithium-ion secondary batteries, the ceramic electrode is robust because it is composed of ceramic (sintered body), and the battery can be reassembled by replacing the electrolytic solution 22 any number of times. Advantageously, the main deterioration modes in such a semi-solid battery are only “reaction between an electrolyte and an active material” and “dissolution of the positive electrode active material” among the above-mentioned extremely diverse deterioration factors. That is, since the positive electrode 12 and/or the negative electrode 16, which is a ceramic electrode in the semi-solid battery, is composed of ceramic (that is, a sintered body), it is free from components that cause deterioration, such as an organic binder (the organic binder disappears by sintering). As a result, the ceramic electrode free from binders or the like is less deteriorated (there is no deterioration due to the binder). In addition, since the ceramic electrode is made of ceramics, it can be taken out in its original form even after use and can be easily handled. Moreover, since this electrode is made of ceramics alone (even if the metal foil is attached, it can be detached or separated), it is possible to perform heat treatment such as degreasing and firing as well as cleaning. Although deterioration due to oxidative decomposition of the electrolytic solution 22 occurs, the performance of the battery can be restored to some extent simply by replacing the electrolytic solution 22 because the deterioration of the ceramic electrode itself is small. Accordingly, the method of the present invention makes it possible to reassemble a lithium-ion secondary battery whose performance is sufficiently restored using a used lithium-ion secondary battery with simple procedure at low cost.

### (1) Preparation of Used Lithium-Ion Secondary Battery

The used lithium-ion secondary battery 10 is prepared. The lithium-ion secondary battery 10 comprises a battery element 21, an electrolytic solution 22, and a battery container 24 accommodating the battery element 21 and the electrolytic solution 22. The battery element 21 includes a positive electrode 12, a separator 20, and a negative electrode 16, wherein at least one of the positive electrode 12 and the negative electrode 16 is a ceramic electrode. Preferably, both the positive electrode 12 and the negative electrode 16 are ceramic electrodes. That is, the lithium-ion secondary battery 10 is a sintered body-type battery (semi-solid battery) comprising a ceramic electrode together with an electrolytic solution. Such sintered body-type batteries are known as disclosed in Patent Literatures 6 and 7, and the preferable configurations thereof will be described later. In particular, since the ceramic electrode is composed of ceramic (sintered body), the positive electrode 12 and the negative electrode 16 can be handled separately from each other, which is preferable from the viewpoint of improving the working efficiency. Accordingly, battery elements in which a ceramic positive electrode layer, a ceramic separator, and a ceramic negative electrode layer form one integrated sintered body as a whole are excluded from the scope of the present invention because of the difficulty in separating the positive electrode 12 and the negative electrode 16. The battery element may further comprise a positive electrode current collector 14 and/or a negative electrode current collector 18.

### (2) Taking Out Battery Element

The ceramic electrode is taken out from the lithium-ion secondary battery 10 (specifically, the battery container 24) so that the positive electrode 12 and the negative electrode 16 are separated from each other. At this time, the separator 20 may be bonded to the ceramic electrode taken out, and preferable examples of such a form include an integrated sintered body of ceramic electrode/ceramic separator. The battery element 21 may be appropriately taken out according to the configuration of the battery container 24 by detaching part of the battery container 24 (e.g., a negative electrode can 24b), opening the inside of the battery, and taking out the battery element 21 or ceramic electrode (that is, the positive electrode 12 and/or the negative electrode 16). The battery element 21 may be taken out as a whole and then the positive electrode 12 may be separated from the negative electrode 16, or only the ceramic electrode (to which the separator 20 may be bonded), which is the positive electrode 12 or the negative electrode 16, may be taken out while leaving the battery element 21 inside the battery container 24. In any case, the ceramic electrode is composed of ceramic (sintered body), so that the positive electrode 12 and the negative electrode 16 can be handled separately from each other. Therefore, it is advantageous not only in terms of ease of work, but also in that the electrode restoration treatment can be performed under more appropriate procedures and conditions according to the type of ceramic electrode (positive electrode 12 or negative electrode 16). That is, different electrode restoration treatments can each be performed on the positive electrode 12 and the negative electrode 16. Alternatively, only one of the positive electrode 12 and the negative electrode 16 may be subjected to the electrode restoration treatment.

### (3) Electrode Restoration Treatment

The ceramic electrode (that is, the positive electrode 12 and/or the negative electrode 16) taken out is subjected to electrode restoration treatment including cleaning and/or heat treatment. The method of the electrode restoration treatment is not particularly limited as long as it includes cleaning and/or heat treatment that can improve the deteriorated electrode performance. Typically, the electrode restoration treatment is performed by cleaning the ceramic electrode with a polar solvent to remove impurities contained in and/or attached to the ceramic electrode, followed by drying. The polar solvent may be any of a non-aqueous solvent and water. Examples of the non-aqueous solvent include NMP (N-methyl-2-pyrrolidone) and ethanol. The cleaning method with the polar solvent is not specifically limited, but it is preferable to immerse the ceramic electrode in the polar solvent and perform ultrasonic cleaning or stirring.

It is preferable to heat, at 300 to 1000° C., the ceramic electrode thus cleaned and dried, in that the electrode performance can be further enhanced. Since the ceramic electrode in the present invention (except the positive electrode current collector 14 and/or the negative electrode current collector 18) is composed of ceramics alone, they can be subjected to heat treatment such as degreasing and firing (which cannot be applied to coating electrodes containing active materials and binders). In this case, the ceramic electrode is preferably degreased and/or fired, more preferably both degreased and fired. The ceramic electrode may be degreased by heating the ceramic electrode preferably at 300 to 600° C., more preferably at 400 to 600° C., and the preferable retention time in the aforementioned temperature range is 0.5 to 20 hours, more preferably 2 to 20 hours. As a result, unnecessary components or impurities (SEI or the like) remaining in the ceramic electrode can be eliminated or burned off, the residual amount can be further reduced, and the battery performance can be further improved. The ceramic electrode may be fired by heating the battery element preferably at 650 to 1000° C., more preferably at 700 to 950° C., and the preferable retention time in the aforementioned temperature range is 0.01 to 20 hours, more preferably 0.01 to 15 hours. Thus, the crystallinity of the substance can be restored or improved, and the battery performance can be further enhanced. Further, sintering the electrode active material more can improve the strength of the electrode active material layer. In addition, it is also possible to optimize the lithium content in the electrode active materials and promote the restoration of the performance of the positive electrode 12 and/or the negative electrode 16 by coexistence of a lithium compound and/or lithium-containing atmosphere in heat treatment such as degreasing and firing. The degreasing conditions and/or firing conditions described above are also applicable in the same manner to the case where the separator 20 is bonded to the ceramic electrode (typically, an integrated sintered body of ceramic electrode/ceramic separator).

In the case where the ceramic electrode further includes the positive electrode current collector 14 and/or the negative electrode current collector 18, it is preferable to detach the positive electrode current collector 14 and/or the negative electrode current collector 18 before and/or during the cleaning and attach the positive electrode current collector 14 and/or the negative electrode current collector 18 to the ceramic electrode after the electrode restoration treatment. Thus, the ceramic electrode alone can be subjected to the cleaning or heat treatment as described above. The positive electrode current collector 14 and/or the negative electrode current collector 18 attached to the ceramic electrode after the electrode restoration treatment are not limited to a new positive electrode current collector 14 and/or a new negative electrode current collector 18, and the positive electrode current collector 14 and/or the negative electrode current collector 18 detached may be recycled.

### (4) Battery Assembly

The ceramic electrode subjected to the electrode restoration treatment is put back into the battery container 24 to assemble the lithium-ion secondary battery 10. The assembly of the lithium-ion secondary battery 10 may be performed in any procedure and is not particularly limited, as long as the original structure of the lithium-ion secondary battery 10 is reproduced. For components other than the ceramic electrode subjected to the electrode restoration treatment, the same ones originally included in the used lithium-ion secondary battery 10 may be recycled, or they may be replaced with new ones.

For example, after the ceramic electrode is taken out and before it is put back into the battery container 24, the battery container 24 may be replaced with another battery container 24. Further, when or before the lithium-ion secondary battery 10 is assembled, the positive electrode 12 or negative electrode 16 other than the ceramic electrode subjected to the electrode restoration treatment may be replaced with a new or comparable positive electrode 12 or negative electrode 16. The separator 20 may also be replaced with a new or comparable separator 20.

The electrolytic solution 22 inside the lithium-ion secondary battery 10 (specifically, inside the battery container 24) may be replaced with a fresh electrolytic solution 22. The electrolytic solution 22 is preferably replaced after taking out the ceramic electrode (for example, when or before the battery is assembled), but there is no limitation to this. For example, in the case of replacing the battery container 24, the fresh electrolytic solution 22 may be put into another replaced battery container 24. The fresh electrolytic solution 22 may have the same composition as the electrolytic solution 22 initially used in the lithium-ion secondary battery 10, or the electrolytic solution 22 having a different composition from the initially used electrolytic solution 22 may be used, as long as an acceptable performance can be exerted. For example, the electrolytic solution 22 that provides better performance as compared to the initially used electrolytic solution 22 may be used. Details of preferable examples of the electrolytic solution 22 will be described later.

### Lithium-Ion Secondary Battery

As shown in FIG. 1, the lithium-ion secondary battery 10 includes the positive electrode 12, the negative electrode 16, the separator 20, the electrolytic solution 22, and the battery container 24. At least one of the positive electrode 12 and the negative electrode 16 is a ceramic electrode, but in the illustrated example, both the positive electrode 12 and the negative electrode 16 are depicted as being ceramic electrodes. The separator 20 is interposed between the positive electrode 12 and the negative electrode 16. The positive electrode 12, the negative electrode 16, and the separator 20 are impregnated with the electrolytic solution 22. The battery container 24 has a closed space, and the positive electrode 12, the negative electrode 16, the separator 20, and the electrolytic solution 22 are accommodated in the closed space.

The positive electrode 12 is preferably a ceramic positive electrode. In this case, the ceramic positive electrode 12 is preferably composed of a lithium complex oxide sintered body. The fact that the positive electrode 12 is composed of a sintered body means that the positive electrode 12 is free from binders or conductive additives. This is because, even if a binder is contained in a green sheet, the binder disappears or burns out during firing. Since the positive electrode 12 contains no binder, there is an advantage that deterioration of the positive electrode due to the electrolytic solution 22 can be avoided. The lithium complex oxide constituting the sintered body is particularly preferably lithium cobaltite (typically, LiCoO₂, which may be hereinafter abbreviated as LCO). Various lithium complex oxide sintered plates or LCO sintered plates are known, and those disclosed in Patent Literature 6 (JP6374634B) can be referred to, for example. However, in the case where the negative electrode 16 is a ceramic electrode, the positive electrode 12 does not necessarily have to be a ceramic electrode, and may be a powder-dispersed positive electrode (so-called coated electrode) produced by applying and drying a positive electrode mixture containing a positive electrode active material, a conductive additive, a binder, or the like.

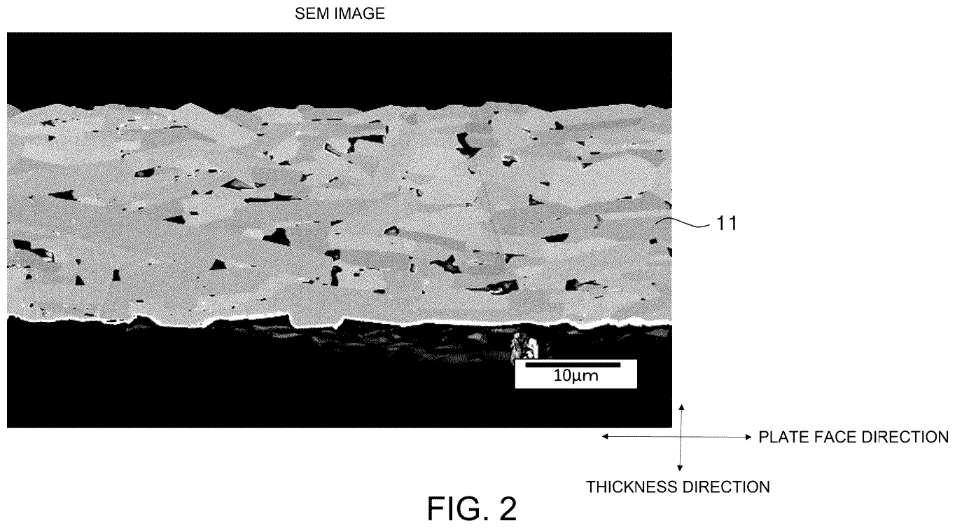

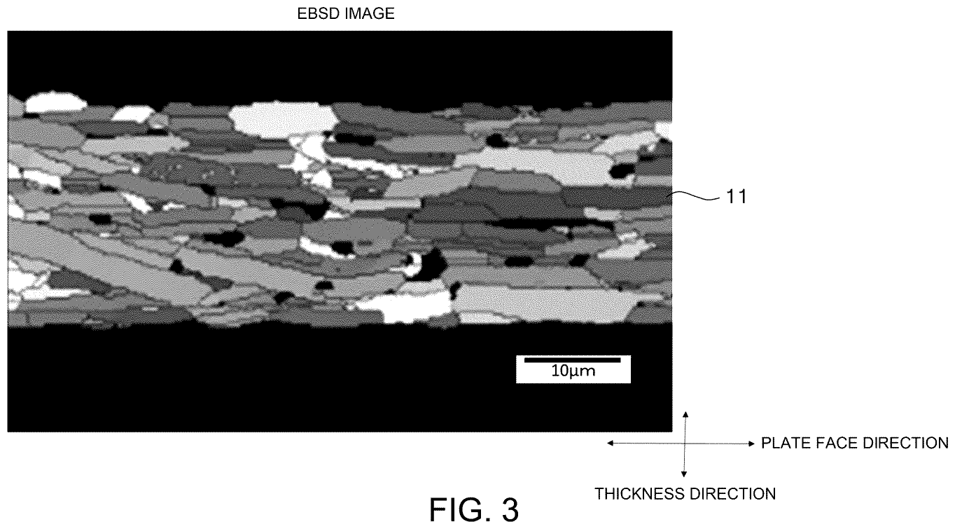

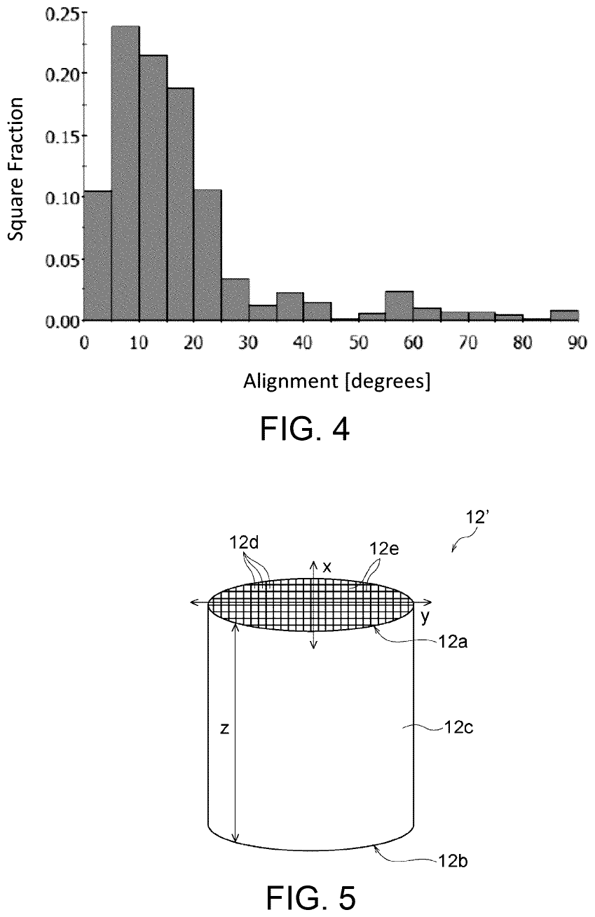

In the case where the ceramic positive electrode 12 is composed of a lithium complex oxide sintered body, the ceramic positive electrode 12 (that is, the lithium complex oxide sintered body) is preferably an oriented positive electrode containing a plurality of primary grains composed of a lithium complex oxide, the plurality of primary grains being oriented at an average orientation angle of over 0° and 30° or less with respect to the principal plane of the positive electrode (that is, the layer face of the positive electrode layer). Since the oriented positive electrode is oriented as described above, it is particularly suitable for reuse because it is less susceptible to structural damage due to expansion and contraction associated with charging and discharging. FIG. 2 shows an example of a SEM image in a cross section perpendicular to the layer face of the oriented ceramic positive electrode 12, and FIG. 3 shows an electron backscatter diffraction (EBSD: Electron Backscatter Diffraction) image in a cross section perpendicular to the principal plane of the oriented ceramic positive electrode 12. Further, FIG. 4 shows an area-based histogram showing the distribution of orientation angles of primary grains 11 in the EBSD image shown in FIG. 3. In the EBSD image shown in FIG. 3, the discontinuity of crystal orientation can be observed. In FIG. 3, the orientation angle of each primary grain 11 is indicated by the shading of color. A darker color indicates a smaller orientation angle. The orientation angle is a tilt angle formed by plane (003) of the primary grains 11 to the principal plane direction. In FIGS. 2 and 3, the points shown in black within the oriented ceramic positive electrode 12 represent pores.

The oriented ceramic positive electrode 12 is an oriented sintered body composed of the plurality of primary grains 11 bound to each other. The primary grains 11 are each mainly in the form of a plate but may include rectangular, cubic, and spherical grains. The cross-sectional shape of each primary grain 11 is not particularly limited and may be a rectangular shape, a polygonal shape other than the rectangular shape, a circular shape, an elliptical shape, or a complex shape other than above.

The primary grains 11 are composed of a lithium complex oxide. The lithium complex oxide is an oxide represented by LiₓMO₂ (where 0.05<x<1.10 is satisfied, M represents at least one transition metal, and M typically contains one or more of Co, Ni, and Mn). The lithium complex oxide has a layered rock-salt structure. The layered rock-salt structure refers to a crystalline structure in which lithium layers and transition metal layers other than lithium are alternately stacked with oxygen layers interposed therebetween, that is, a crystalline structure in which transition metal ion layers and single lithium layers are alternately stacked with oxide ions therebetween (typically, an α-NaFeO₂ structure, i.e., a cubic rock-salt structure in which transition metal and lithium are regularly disposed in the axis direction). Examples of the lithium complex oxide include LixCoO₂ (lithium cobaltate), LixNiO₂ (lithium nickelate), LixMnO₂ (lithium manganate), LixNiMnO₂ (lithium nickel manganate), LixNiCoO₂ (lithium nickel cobaltate), LixCoNiMnO₂ (lithium cobalt nickel manganate), and LixCoMnO₂ (lithium cobalt manganate), particularly preferably LixCoO₂ (lithium cobaltate, typically LiCoO₂). The lithium complex oxide may contain one or more elements selected from Mg, Al, Si, Ca, Ti, V, Cr, Fe, Cu, Zn, Ga, Ge, Sr, Y, Zr, Nb, Mo, Ag, Sn, Sb, Te, Ba, Bi, and W.

As shown in FIGS. 3 and 4, the average of the orientation angles of the primary grains 11, that is, the average orientation angle is over 0° and 30° or less. This brings various advantages as follows. First, since each primary grain 11 lies in a direction inclined from the thickness direction, the adhesion between the primary grains can be improved. As a result, the lithium ion conductivity between a certain primary grain 11 and each of other primary grains 11 adjacent to the primary grain 11 on both sides in the longitudinal direction can be improved, so that the rate characteristic can be improved. Secondly, the rate characteristic can be further improved. This is because, when lithium ions move in and out, the oriented ceramic positive electrode 12 expands and contracts smoothly since the oriented ceramic positive electrode 12 expands and contracts more in the thickness direction than in the principal plane direction, as described above, and thus the lithium ions also move in and out smoothly. Thirdly, since the expansion and contraction of the oriented ceramic positive electrode 12 following the inflow and outflow of lithium ions are predominant in the direction perpendicular to the principal plane, stress is less likely to occur at the bonding interface between the oriented ceramic positive electrode 12 and the ceramic separator 20, thereby making it easy to maintain good bonding at the interface.

The average orientation angle of the primary grains 11 is obtained by the following method. First, three horizontal lines that divide the oriented ceramic positive electrode 12 into four equal parts in the thickness direction and three vertical lines that divide the oriented ceramic positive electrode 12 into four equal parts in the principal plane direction are drawn in an EBSD image of a rectangular region of 95 μm×125 μm observed at a magnification of 1000 times, as shown in FIG. 3. Next, the average orientation angle of the primary grains 11 is obtained by arithmetically averaging the orientation angles of all the primary grains 11 intersecting at least one of the three horizontal lines and the three vertical lines. The average orientation angle of the primary grains 11 is preferably 30° or less, more preferably 25° or less, from the viewpoint of further improving the rate characteristics. From the viewpoint of further improving the rate characteristics, the average orientation angle of the primary grains 11 is preferably 2° or more, more preferably 5° or more.

As shown in FIG. 4, the orientation angles of the primary grains 11 may be widely distributed from 0° to 90°, but most of them are preferably distributed in the region of over 0° and 30° or less. That is, when a cross section of the oriented sintered body constituting the oriented ceramic positive electrode 12 is analyzed by EBSD, the total area of the primary grains 11 with an orientation angle of over 0° and 30° or less to the layer face of the oriented ceramic positive electrode 12 (which will be hereinafter referred to as low-angle primary grains) out of the primary grains 11 contained in the cross section analyzed is preferably 70% or more, more preferably 80% or more, with respect to the total area of the primary grains 11 contained in the cross section (specifically, 30 primary grains 11 used for calculating the average orientation angle). Thereby, the proportion of the primary grains 11 with high mutual adhesion can be increased, so that the rate characteristic can be further improved. Further, the total area of grains with an orientation angle of 20° or less among the low-angle primary grains is more preferably 50% or more with respect to the total area of 30 primary grains 11 used for calculating the average orientation angle. Further, the total area of grains with an orientation angle of 10° or less among the low-angle primary grains is more preferably 15% or more with respect to the total area of 30 primary grains 11 used for calculating the average orientation angle.

Since the primary grains 11 are each mainly in the form of a plate, the cross section of each primary grain 11 extends in a predetermined direction, typically in a substantially rectangular shape, as shown in FIGS. 2 and 3. That is, when the cross section of the oriented sintered body is analyzed by EBSD, the total area of the primary grains 11 with an aspect ratio of 4 or more in the primary grains 11 contained in the cross section analyzed is preferably 70% or more, more preferably 80% or more, with respect to the total area of the primary grains 11 contained in the cross section (specifically, 30 primary grains 11 used for calculating the average orientation angle). Specifically, in the EBSD image as shown in FIG. 3, the mutual adhesion between the primary grains 11 can be further improved by above, as a result of which the rate characteristic can be further improved. The aspect ratio of each primary grain 11 is a value obtained by dividing the maximum Feret diameter of the primary grain 11 by the minimum Feret diameter. The maximum Feret diameter is the maximum distance between two parallel straight lines that interpose the primary grain 11 therebetween on the EBSD image in observation of the cross section. The minimum Feret diameter is the minimum distance between two parallel straight lines that interpose the primary grain 11 therebetween on the EBSD image.

The mean diameter of the plurality of primary grains constituting the oriented sintered body is preferably 5 μm or more. Specifically, the mean diameter of the 30 primary grains 11 used for calculating the average orientation angle is preferably 5 μm or more, more preferably 7 μm or more, further preferably 12 μm or more. Thereby, since the number of grain boundaries between the primary grains 11 in the direction in which lithium ions conduct is reduced, and the lithium ion conductivity as a whole is improved, the rate characteristic can be further improved. The mean diameter of the primary grains 11 is a value obtained by arithmetically averaging the equivalent circle diameters of the primary grains 11. An equivalent circle diameter is the diameter of a circle having the same area as each primary grain 11 on the EBSD image.

The ceramic positive electrode 12 preferably includes pores. The electrolytic solution can penetrate into the sintered body by the sintered body including pores, particularly open pores, when the sintered body is integrated into a battery as a positive electrode. As a result, the lithium ion conductivity can be improved. This is because there are two types of conduction of lithium ions within the sintered body: conduction through constituent grains of the sintered body; and conduction through the electrolytic solution within the pores, and the conduction through the electrolytic solution within the pores is overwhelmingly faster.

The ceramic positive electrode 12 (preferably, the lithium complex oxide sintered body) preferably has a porosity of 20 to 60%, more preferably 25 to 55%, further preferably 30 to 50%, particularly preferably 30 to 45%. The stress relief effect by the pores and the increase in capacity can be expected, and the mutual adhesion between the primary grains 11 can be further improved, so that the rate characteristics can be further improved. The porosity of the sintered body is calculated by polishing a cross section of the positive electrode layer with CP (cross-section polisher) polishing, thereafter observing the cross section at a magnification of 1000 times with SEM, and binarizing the SEM image obtained. The average equivalent circle diameter of pores formed inside the oriented sintered body is not particularly limited but is preferably 8 μm or less. The smaller the average equivalent circle diameter of the pores, the mutual adhesion between the primary grains 11 can be improved more. As a result, the rate characteristic can be improved more. The average equivalent circle diameter of the pores is a value obtained by arithmetically averaging the equivalent circle diameters of 10 pores on the EBSD image. An equivalent circle diameter is the diameter of a circle having the same area as each pore on the EBSD image. Each of the pores formed inside the oriented sintered body is preferably an open pore connected to the outside of the positive electrode 12.

The ceramic positive electrode 12, that is, the lithium complex oxide sintered body preferably has a mean pore diameter of 0.1 to 10.0 μm, more preferably 0.2 to 5.0 μm, further preferably 0.25 to 3.0 μm. Within such a range, stress concentration is suppressed from occurring locally in large pores, and the stress is easily released uniformly in the sintered body.

The ceramic positive electrode 12 (the positive electrode layer) preferably has a thickness of 60 to 450 μm, more preferably 70 to 350 μm, further preferably 90 to 300 μm. The thickness within such a range can improve the energy density of the lithium-ion secondary battery 10 by increasing the capacity of the active material per unit area together with suppressing the deterioration of the battery characteristics (particularly, the increase of the resistance value) due to repeated charging/discharging.

The negative electrode 16 is preferably a ceramic negative electrode. In this case, the ceramic negative electrode 16 is preferably composed of a titanium-containing sintered body. However, in the case where the positive electrode 12 is a ceramic electrode, the negative electrode 16 does not necessarily have to be a ceramic electrode, and may be a powder-dispersed negative electrode (so-called coated electrode) produced by applying and drying a negative electrode mixture containing a negative electrode active material, a conductive additive, a binder, or the like.

In the case where the ceramic negative electrode 16 is composed of a titanium-containing sintered body, the ceramic negative electrode 16 (that is, the titanium-containing sintered body) preferably contains lithium titanate Li₄Ti₅O₁₂ (which will be hereinafter referred to as LTO) or niobium titanium complex oxide Nb₂TiO₇, more preferably LTO. LTO is typically known to have a spinel structure but can have other structures during charging and discharging. For example, the reaction of LTO proceeds in the two-phase coexistence of Li₄Ti₅O₁₂ (spinel structure) and Li₇Ti₅O₁₂ (rock salt structure) during charging and discharging. Accordingly, the structure of LTO is not limited to the spinel structure.

The fact that the ceramic negative electrode 16 is composed of a sintered body means that the negative electrode 16 contains no binder or conductive agent. This is because, even if a binder is contained in a green sheet, the binder disappears or burns out during firing. Since the negative electrode layer contains no binder, high capacity and good charge/discharge efficiency can be achieved by high packing density of the negative electrode active material (for example, LTO or Nb₂TiO₇). The LTO sintered body can be produced according to the method described in Patent Literature 7 (JP6392493B).

The ceramic negative electrode 16 (preferably, the titanium-containing sintered body) has a structure that a plurality (namely, a large number) of primary grains are bonded. Accordingly, these primary grains are preferably composed of LTO or Nb₂TiO₇.

The ceramic negative electrode 16 (negative electrode layer) preferably has a thickness of 70 to 500 μm, preferably 85 to 400 μm, more preferably 95 to 350 μm. As the thickness of the negative electrode 16 increases, it is easier to achieve a battery with high capacity and high energy density. The thickness of the negative electrode 16 is determined by measuring the distance between the two substantially parallel faces of the layer, for example, when the cross section of the negative electrode 16 is observed by SEM (scanning electron microscopy).

The primary grain size that is the average grain size of the plurality of primary grains forming the ceramic negative electrode 16 is preferably 1.2 μm or less, more preferably 0.02 to 1.2 μm, further preferably 0.05 to 0.7 μm. Within such a range, the lithium ion conductivity and the electron conductivity are easily compatible with each other, which contributes to improving the rate performance.

The ceramic negative electrode 16 preferably includes pores. The electrolytic solution can penetrate into the sintered body by the sintered body including pores, particularly open pores, when the sintered body is integrated into a battery as a negative electrode layer. As a result, the lithium ion conductivity can be improved. This is because there are two types of conduction of lithium ions within the sintered body: conduction through constituent grains of the sintered body; and conduction through the electrolytic solution within the pores, and the conduction through the electrolytic solution within the pores is overwhelmingly faster.

The ceramic negative electrode 16 preferably has a porosity of 20 to 60%, more preferably 30 to 55%, further preferably 35 to 50%. Within such a range, the lithium ion conductivity and the electron conductivity are easily compatible with each other, which contributes to improving the rate performance.

The ceramic negative electrode 16 has a mean pore diameter of 0.08 to 5.0 μm, preferably 0.1 to 3.0 μm, more preferably 0.12 to 1.5 μm. Within such a range, the lithium ion conductivity and the electron conductivity are easily compatible with each other, which contributes to improving the rate performance.

The separator 20 is preferably a ceramic separator. The separator 20 is a microporous film made of ceramic. The ceramic separator 20 is advantageous in that it, of course, has excellent heat resistance and can be produced as one integrated sintered plate together with either positive electrode 12 or negative electrode 16 as a whole. The ceramic contained in the ceramic separator 20 is preferably at least one selected from MgO, Al₂O₃, ZrO₂, SiC, Si₃N₄, AlN, and cordierite, more preferably at least one selected from MgO, Al₂O₃, and ZrO₂. The ceramic separator 20 preferably has a thickness of 3 to 40 μm, more preferably 5 to 35 μm, further preferably 10 to 30 μm. The ceramic separator 20 preferably has a porosity of 30 to 85%, more preferably 40 to 80%. Alternatively, the separator 20 may be a polymeric microporous film. In this case, the separator 20 is preferably a separator made of polyolefin, polyimide, polyester (for example, polyethylene terephthalate (PET)), or cellulose. Examples of the polyolefin include polypropylene (PP), polyethylene (PE), and combinations thereof.

The electrolytic solution 22 is not specifically limited, and commercially available electrolytic solutions for lithium batteries such as a solution obtained by dissolving a lithium salt (e.g., LiPF₆) in a non-aqueous solvent such as an organic solvent (e.g., a mixed solvent of ethylene carbonate (EC) and methyl ethyl carbonate (MEC), a mixed solvent of ethylene carbonate (EC) and diethyl carbonate (DEC), or a mixed solvent of ethylene carbonate (EC) and ethyl methyl carbonate (EMC)) may be used.

In the case of forming a lithium-ion secondary battery having excellent heat resistance, the electrolytic solution 22 preferably contains lithium borofluoride (LiBF₄) in a non-aqueous solvent. In this case, the non-aqueous solvent is preferably at least one selected from the group consisting of γ-butyrolactone (GBL), ethylene carbonate (EC) and propylene carbonate (PC), more preferably a mixed solvent composed of EC and GBL, a single solvent composed of PC, a mixed solvent composed of PC and GBL, or a single solvent composed of GBL, particularly preferably a mixed solvent composed of EC and GBL or a single solvent composed of GBL. The non-aqueous solvent has an increased boiling point by containing γ-butyrolactone (GBL), which considerably improves the heat resistance. From such a viewpoint, the volume ratio of EC:GBL in the EC and/or GBL containing non-aqueous solvent is preferably 0:1 to 1:1 (GBL ratio: 50 to 100% by volume), more preferably 0:1 to 1:1.5 (GBL ratio: 60 to 100% by volume), further preferably 0:1 to 1:2 (GBL ratio: 66.6 to 100% by volume), particularly preferably 0:1 to 1:3 (GBL ratio: 75 to 100% by volume). The lithium borofluoride (LiBF₄) to be dissolved in the non-aqueous solvent is an electrolyte having a high decomposition temperature, which also considerably improves the heat resistance. The LiBF₄ concentration in the electrolytic solution 22 is preferably 0.5 to 2 mol/L, more preferably 0.6 to 1.9 mol/L, further preferably 0.7 to 1.7 mol/L, particularly preferably 0.8 to 1.5 mol/L.

The electrolytic solution 22 may further contain vinylene carbonate (VC) and/or fluoroethylene carbonate (FEC) and/or vinyl ethylene carbonate (VEC) as additives. Both VC and FEC have excellent heat resistance. Accordingly, a SEI film having excellent heat resistance can be formed on the surface of the negative electrode 16 by the electrolytic solution 22 containing such additives.

The battery container 24 includes a closed space, and the closed space accommodates the positive electrode 12, the negative electrode 16, the separator 20, and the electrolytic solution 22. The battery container 24 may be appropriately selected corresponding to the type of the lithium-ion secondary battery 10. For example, in the case where the lithium-ion secondary battery is in a form of coin-shaped battery as shown in FIG. 1, the battery container 24 typically includes the positive electrode can 24a, the negative electrode can 24b, and the gasket 24c, and the positive electrode can 24a and the negative electrode can 24b are crimped via the gasket 24c to form the closed space. The positive electrode can 24a and the negative electrode can 24b can be made of metals such as stainless steel and are not specifically limited. The gasket 24c can be an annular member made of an insulating resin such as polypropylene, polytetrafluoroethylene, and PFA resin and is not particularly limited.

The lithium-ion secondary battery 10 preferably further includes a positive electrode current collector 14 and/or a negative electrode current collector 18. The positive electrode current collector 14 and the negative electrode current collector 18 are not specifically limited but are preferably metal foils such as copper foils and aluminum foils. The positive electrode current collector 14 is preferably interposed between the positive electrode 12 and the battery container 24 (e.g., the positive electrode can 24a), and the negative electrode current collector 18 is preferably interposed between the negative electrode 16 and the battery container 24 (e.g., the negative electrode can 24b). Further, a positive electrode side carbon layer 13 is preferably provided between the positive electrode 12 and the positive electrode current collector 14 for reducing the contact resistance. Likewise, a negative electrode side carbon layer 17 is preferably provided between the negative electrode 16 and the negative electrode current collector 18 for reducing the contact resistance. Both the positive electrode side carbon layer 13 and the negative electrode side carbon layer 17 are preferably composed of a conductive carbon and may be formed, for example, by applying a conductive carbon paste by screen printing or the like.

### Honeycomb-Type Secondary Battery

The ceramic positive electrode 12 or the ceramic negative electrode 16 may have a honeycomb structure. In this way, a three-dimensional structure suited for high capacity and high power output can be achieved, in which a plurality of negative electrodes 16 or positive electrodes 12 can be accommodated inside the honeycomb structure. FIG. 5 shows an example of a honeycomb-type ceramic positive electrode 12′. The honeycomb-type ceramic positive electrode 12′ has a columnar honeycomb structure. This columnar honeycomb structure has a first end face 12a, a second end face 12b parallel to the first end face 12a, and an outer side face 12c perpendicular to the first end face 12a and the second end face 12b. The columnar honeycomb structure also has a plurality of holes 12d extending from the first end face 12a to the second end face 12b, and these holes 12d are compartmentalized by a partition wall 12e.

The honeycomb-type ceramic positive electrode 12′ is preferably composed of a lithium complex oxide sintered body, and more preferably of an oriented lithium complex oxide sintered body. In this case, when the central axis of the columnar honeycomb structure parallel to the outer side face 12c or an axis parallel thereto is defined as the z-axis, a plurality of primary grains are preferably oriented in the z-axis direction (for example, at an average orientation angle of over 0° and 30° or less with respect to the z-axis). In addition, when the columnar honeycomb structure is planarly viewed in the z-axis direction and one direction of the latticed partition wall 12e is assigned to the x-axis and the other direction to the y-axis, it is preferable that the primary grains constituting the partition wall 12e in the x-axis direction are oriented in the x-axis direction (for example, at an average orientation angle of over 0° and 30° or less with respect to the x-axis), and that the primary grains constituting the partition wall 12e in the y-axis direction are oriented in the y-axis direction (for example, at an average orientation angle of over 0° and 30° or less with respect to the y-axis). In this way, the primary particles are oriented in all of the x-axis direction, y-axis direction, and z-axis direction of the columnar honeycomb structure, and thus lower resistance is considered to be realized not only in the z-axis direction (length direction of the columnar honeycomb structure) but also in the x-axis direction and y-axis direction (that is, x-y plane direction), which promotes lithium ion conduction and electron conduction. This results in improved battery characteristics (for example, discharge rate characteristic) in the secondary battery 10.

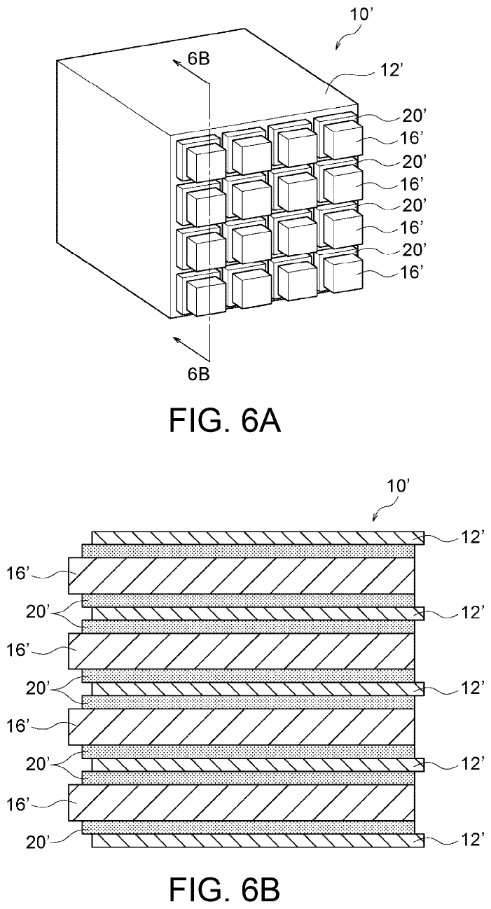

FIGS. 6A and 6B show a lithium-ion secondary battery 10′ having the honeycomb-type ceramic positive electrode 12′. For the sake of convenience of illustration, these figures depict only a portion of the columnar honeycomb structure that has been cut out in the shape of a square column. This secondary battery 10′ has the honeycomb-type ceramic positive electrode 12′, a plurality of negative electrodes 16′, a separator 20′, an electrolytic solution (not shown), and a battery container (not shown). The plurality of negative electrodes 16′ are inserted into the plurality of holes of the honeycomb-type ceramic positive electrode 12′, and the ends of the negative electrodes 16′ extend out from the first end face 12a or the second end face 12b. The separator 20′ is interposed between the honeycomb-type ceramic positive electrode 12′ and the negative electrodes 16′.

The lithium-ion secondary battery 10′ having the honeycomb-type ceramic positive electrode 12′ may be produced by any production method. For example, the separator 20′ may be formed in advance on the surface of the negative electrodes 16′, and the negative electrodes 16′ covered with the separator 20′ may be inserted into the holes 12d of the honeycomb-type ceramic positive electrode 12′. In this case, the formation of the separator 20′ on the surface of the negative electrodes 16′ can be performed by applying (for example, by dip coating) a slurry containing a ceramic powder (for example, MgO powder), a binder, a dispersive medium, and the like to the negative electrodes 16′ and drying it. Alternatively, the separator 20′ may be formed on the surface of the partition wall 12e of the honeycomb-type ceramic positive electrode 12′, and the rod-shaped negative electrodes 16′ may be inserted into the holes 12d. In this case, instead of inserting the rod-shaped negative electrodes 16′, a slurry containing a negative electrode active material (for example, graphite slurry) may be poured into the holes 12d to form the negative electrodes 16′.

The method for recycling a lithium-ion secondary battery according to the present invention is also preferably applicable to the honeycomb-type secondary battery 10′ as described above. In this case as well, the honeycomb-type ceramic positive electrode 12′ and the negative electrodes 16′ can be separated and subjected to the electrode restoration treatment. For example, in the case where the negative electrodes 16′ are rod-shaped, the positive electrode 12′ and the negative electrodes 16′ can be separated by pulling the rod-shaped negative electrodes 16′ out of the honeycomb-type ceramic positive electrode 12′. Also, in the case where the negative electrodes 16′ are composed of a slurry containing a negative electrode active material (for example, graphite slurry) poured into the holes 12d of the honeycomb-type ceramic positive electrode 12′, the positive electrode 12′ and the negative electrodes 16′ may be separated by eluting the negative electrode active material slurry using a solvent (for example, NMP (N-methyl-2-pyrrolidone)). Unlike the above configuration, in the case where the negative electrode is of honeycomb-type ceramic and the positive electrode is a positive electrode in the form of rods or slurry, the positive electrodes and the negative electrode can also be separated and subjected to the electrode restoration treatment by the same method as described above.

### EXAMPLES

The invention will be illustrated in more detail by the following examples. In the following examples, LiCoO₂ will be abbreviated as “LCO”, and Li₄Ti₅O₁₂ will be abbreviated as “LTO”.

### Example 1

### (1) Preparation of LCO Green Sheet (Positive Electrode Green Sheet)

First, Co₃O₄ powder (manufactured by SEIDO CHEMICAL INDUSTRY CO., LTD.) and Li₂CO₃ powder (manufactured by THE HONJO CHEMICAL CORPORATION) weighed to a molar ratio Li/Co of 1.01 were mixed, and thereafter the mixture was kept at 780° C. for 5 hours. The resultant powder was milled into a volume-based D50 of 0.4 μm with a pot mill to yield powder composed of platy LCO particles. The resultant LCO powder (100 parts by weight), a dispersive medium (toluene:isopropanol=1:1) (100 parts by weight), a binder (polyvinyl butyral: Product No. BM-2, manufactured by SEKISUI CHEMICAL CO., LTD.) (10 parts by weight), a plasticizer (DOP: Di(2-ethylhexyl)phthalate, manufactured by Kurogane Kasei Co., Ltd.) (4 parts by weight), and a dispersant (product name: RHEODOL SP-O30, manufactured by Kao Corporation) (2 parts by weight) were mixed. The resultant mixture was defoamed by stirring under reduced pressure to prepare a LCO slurry with a viscosity of 4000 cP. The viscosity was measured with an LVT viscometer manufactured by Brookfield. The slurry prepared was formed into a LCO green sheet onto a PET film by a doctor blade process. The thickness of the LCO green sheet was adjusted to 60 μm after firing.

### (2) Preparation of LTO Green Sheet (Negative Electrode Green Sheet)

First, LTO powder (volume-based D50 particle size: 0.06 μm, manufactured by Sigma-Aldrich Japan) (100 parts by weight), a dispersive medium (toluene:isopropanol=1:1) (100 parts by weight), a binder (polyvinyl butyral: Product No. BM-2, manufactured by SEKISUI CHEMICAL CO., LTD.) (20 parts by weight), a plasticizer (DOP: Di(2-ethylhexyl)phthalate, manufactured by Kurogane Kasei Co., Ltd.) (4 parts by weight), and a dispersant (product name: RHEODOL SP-O30, manufactured by Kao Corporation) (2 parts by weight) were mixed. The resultant negative electrode raw material mixture was defoamed by stirring under reduced pressure to prepare a LTO slurry with a viscosity of 4000 cP. The viscosity was measured with an LVT viscometer manufactured by Brookfield. The slurry prepared was formed into a LTO green sheet onto a PET film by a doctor blade process. The thickness of the LTO green sheet was adjusted to 70 μm after firing.

### (3) Preparation of MgO Green Sheet (Separator Green Sheet)

Magnesium carbonate powder (manufactured by Konoshima Chemical Co., Ltd.) was heated at 900° C. for 5 hours to obtain MgO powder. The resultant MgO powder and glass frit (CK0199, manufactured by Nippon Frit Co., Ltd. (currently, TAKARA STANDARD CO., LTD.)) were mixed at a weight ratio of 4:1. The resultant mixed powder (volume-based D50 particle size: 0.4 μm) (100 parts by weight), a dispersive medium (toluene:isopropanol=1:1) (100 parts by weight), a binder (polyvinyl butyral: Product No. BM-2, manufactured by SEKISUI CHEMICAL CO., LTD.) (20 parts by weight), a plasticizer (DOP: Di(2-ethylhexyl)phthalate, manufactured by Kurogane Kasei Co., Ltd.) (4 parts by weight), and a dispersant (product name: RHEODOL SP-O30, manufactured by Kao Corporation) (2 parts by weight) were mixed. The resultant raw material mixture was defoamed by stirring under reduced pressure to prepare a slurry with a viscosity of 4000 cP. The viscosity was measured with an LVT viscometer manufactured by Brookfield. The slurry prepared was formed into a separator green sheet onto a PET film by a doctor blade process. The thickness of the separator green sheet was adjusted to 25 μm after firing.

### (4a) Production of Positive Electrode/Separator Integrated Sintered Plate

The LCO green sheet (positive electrode green sheet) and the MgO green sheet (separator green sheet) were stacked, and the resultant laminate was pressed by CIP (cold isostatic pressing) at 200 kgf/cm² so that the green sheets were pressure-bonded together. The laminate thus pressure-bonded was punched into a circular plate with a diameter of 10 mm using a punching die. The resultant laminate in a form of circular plate was degreased at 600° C. for 5 hours, then heated to 800° C. at 1000° C./h, and kept for 10 minutes to fire, followed by cooling. Thus, a positive electrode/separator integrated sintered plate including two layers of a positive electrode layer (LCO sintered layer) and a ceramic separator (MgO separator) was obtained.

### (4b) Production of Negative Electrode Layer (LTO Sintered Layer)

The LTO green sheet (negative electrode green sheet) was punched into a circular plate with a diameter of 10 mm using a punching die. The resultant circular plate was degreased at 600° C. for 5 hours, then heated to 800° C. at 1000° C./h, and kept for 10 minutes to fire, followed by cooling. Thus, a sintered plate of a negative electrode layer (LTO sintered layer) was obtained.

### (5) Production of Lithium-Ion Secondary Battery

The coin-shaped lithium-ion secondary battery 10 as schematically shown in FIG. 1 was produced as follows.

(5a) Adhesion of Negative Electrode Layer and Negative Electrode Current Collector with Conductive Carbon Paste

Acetylene black and polyimide amide were weighed to a mass ratio of 3:1 and mixed with an appropriate amount of NMP (N-methyl-2-pyrrolidone) as a solvent, to prepare a conductive carbon paste as a conductive adhesive. The conductive carbon paste was screen-printed on an aluminum foil as a negative electrode current collector. The negative electrode sintered plate produced in (4b) above was placed so that the negative electrode layer was located within an undried printing pattern (that is, a region coated with the conductive carbon paste), followed by vacuum drying at 60° C. for 30 minutes, to produce a structure with the negative electrode layer and the negative electrode current collector bonded via the negative electrode side carbon layer. The negative electrode side carbon layer had a thickness of 10 μm.

(5b) Preparation of Positive Electrode Current Collector with Carbon Layer

Acetylene black and polyimide amide were weighed to a mass ratio of 3:1 and mixed with an appropriate amount of NMP (N-methyl-2-pyrrolidone) as a solvent, to prepare a conductive carbon paste. The conductive carbon paste was screen-printed on an aluminum foil as a positive electrode current collector, followed by vacuum drying at 60° C. for 30 minutes, to produce a positive electrode current collector with a positive electrode side carbon layer formed on a surface. The positive electrode side carbon layer had a thickness of 5 μm.

### (5c) Assembling of Coin-Shaped Battery

The positive electrode current collector, the positive electrode side carbon layer, the positive electrode/separator integrated sintered plate (the LCO positive electrode layer, and the MgO separator), the negative electrode sintered plate, the negative electrode side carbon layer, and the negative electrode current collector were accommodated between the positive electrode can and the negative electrode can, which would form a battery case, so as to be stacked in this order from the positive electrode can toward the negative electrode can, and an electrolytic solution was filled therein. Thereafter, the positive electrode can and the negative electrode can were crimped via a gasket to be sealed. Thus, the coin cell-shaped lithium-ion secondary battery 10 with a diameter of 12 mm and a thickness of 1.0 mm was produced. At this time, the electrolytic solution was a solution of LiBF₄ (1.5 mol/L) in a mixed organic solvent of ethylene carbonate (EC) and γ-butyrolactone (GBL) at 1:3 (volume ratio).

(6) Measurement of Capacity Retention Rate after Storage

The capacity retention rate after storage of the battery was measured by the following procedure. First, the battery was charged at a constant voltage of 2.7 V in an environment of 25° C. and then discharged at a discharge rate of 0.2 C to measure the initial capacity. Then, a voltage of 2.7 V was applied in an environment of 60° C. and held for 50 days. Finally, the battery was charged at a constant voltage of 2.7 V and then discharged at 0.2 C to measure the capacity after storage. The measured capacity after storage was divided by the initial capacity and multiplied by 100 to obtain a capacity retention rate (%) after storage.

(7) Disassembly, Cleaning, and Reassembly of Battery after Storage

A battery discharged after storage was prepared, and the sealing part which crimped the positive electrode can and the negative electrode can was opened. Then, the negative electrode can and the gasket were detached from the battery, and the positive electrode current collector, the positive electrode/separator integrated sintered plate, the negative electrode sintered plate, and the negative electrode current collector were taken out from the inside. The positive electrode current collector was detached from the positive electrode/separator integrated sintered plate taken out. The positive electrode/separator integrated sintered plate and the negative electrode sintered plate to which the negative electrode current collector was bonded were immersed in an appropriate amount of NMP (N-methyl-2-pyrrolidone) and stirred for 60 minutes. Thus, while dissolving and removing impurities such as the positive electrode side carbon layer bonded to the positive electrode/separator integrated sintered plate, the negative electrode side carbon layer bonded to the negative electrode sintered plate, and the electrolytic solution decomposition product adhering to the positive electrode/separator integrated sintered plate and the negative electrode sintered plate, the negative electrode current collector was separated. The same operation was repeated twice, and the positive electrode/separator integrated sintered plate and negative electrode sintered plate from which impurities have been removed was vacuum-dried at 120° C. for 12 hours. The vacuum-dried positive electrode/separator integrated sintered plate and negative electrode sintered plate were reassembled as a coin-shaped battery by the procedures (5a), (5b), and (5c) above.

### (8) Capacity Retention Rate of Reassembled Battery

The capacity retention rate of the reassembled battery was measured by the following procedures. First, the battery was charged at a constant voltage of 2.7 V in an environment of 25° C. and then discharged at a discharge rate of 0.2 C to measure the capacity after reassembly. The measured capacity after reassembly was divided by the initial capacity and multiplied by 100 to obtain a capacity retention rate (%) after reassembly.

### Example 2

A reassembled battery was evaluated in the same manner as in Example 1, except that the vacuum-dried positive electrode/separator integrated sintered plate and negative electrode sintered plate each degreased by heating at 600° C. for 5 hours were used for reassembling the battery.

### Example 3

A reassembled battery was evaluated in the same manner as in Example 2, except that a degreased positive electrode/separator integrated sintered plate and the negative electrode sintered plate respectively fired at 800° C. for 10 minutes was used for reassembling the battery.

### Example 4

A reassembled battery was evaluated in the same manner as in Example 2, except that only the vacuum-dried positive electrode/separator integrated sintered plate was degreased (that is, the negative electrode sintered plate was not degreased).

### Example 5

A reassembled battery was evaluated in the same manner as in Example 3, except that only the vacuum-dried positive electrode/separator integrated sintered plate was degreased and fired (that is, the negative electrode sintered plate was not degreased and fired).

### Example 6

A reassembled battery was evaluated in the same manner as in Example 3, except that only the vacuum-dried positive electrode/separator integrated sintered plate was subjected to the electrode restoration treatment (cleaning, degreasing, and firing) (that is, the negative electrode sintered plate was not subjected to the electrode restoration treatment).

### Example 7 (Comparison)

A reassembled battery was evaluated in the same manner as in Example 1, except that only the electrolytic solution was replaced without performing the electrode restoration treatment (cleaning and drying) after dismantling the battery for both the positive electrode and the negative electrode.

### Example 8 (Comparison)

A battery was produced in the same manner as in Example 1, except that a) a commercially available LCO-coated electrode (manufactured by Hohsen Corp.) was used as a positive electrode instead of the LCO sintered layer, b) a carbon-coated electrode on a negative electrode current collector produced by the following procedure was used as a negative electrode and a negative electrode current collector, and c) a cellulose separator was used as a separator. Further, the battery was evaluated in the same manner as in Example 1 except that the charging voltage and the applied voltage during storage were changed to 4.2 V.

### (Production of Carbon-Coated Electrode)

A paste containing a mixture of graphite as an active material and polyvinylidene fluoride (PVDF) as a binder was applied to a surface of a negative electrode current collector (aluminum foil), followed by drying, to produce a carbon-coated electrode including a carbon layer with a thickness of 280 μm.

### Evaluation Results

Table 1 shows the evaluation results for Examples 1 to 8.

TABLE 1

| | | | | | | | | | Evaluation | |
|---|---|---|---|---|---|---|---|---|---|---|
| | | | | | | | | | | Capacity |
| | Positive electrode | | | | Negative electrode | | | | Capacity | retention |
| | | Electrode restoration treatment | | | | Electrode restoration treatment | | | retention | rate after |
| | Type of | Cleaning | | | Type of | Cleaning | | | rate after | reassembly |
| | electrode | and drying | Degreasing | Firing | electrode | and drying | Degreasing | Firing | storage (%) | (%) |
| Ex. 1 | Ceramic | Done | None | None | Ceramic | Done | None | None | 76 | 87 |
| | electrode | | | | electrode | | | | | |
| Ex. 2 | Ceramic | Done | Done | None | Ceramic | Done | Done | None | 74 | 88 |
| | electrode | | | | electrode | | | | | |
| Ex. 3 | Ceramic | Done | Done | Done | Ceramic | Done | Done | Done | 76 | 91 |
| | electrode | | | | electrode | | | | | |
| Ex. 4 | Ceramic | Done | Done | None | Ceramic | Done | None | None | 74 | 86 |
| | electrode | | | | electrode | | | | | |
| Ex. 5 | Ceramic | Done | Done | Done | Ceramic | Done | None | None | 75 | 89 |
| | electrode | | | | electrode | | | | | |
| Ex. 6 | Ceramic | Done | Done | Done | Ceramic | None | None | None | 75 | 88 |
| | electrode | | | | electrode | | | | | |
| Ex. 7* | Ceramic | None | None | None | Ceramic | None | None | None | 75 | 77 |
| | electrode | | | | electrode | | | | | |
| Ex. 8* | Coated | Done | None | None | Coated | None | None | None | 71 | 30 |
| | electrode | | | | electrode | | | | | |

The symbol * indicates a comparative example.

As seen from the results shown in Table 1, the capacity retention rate was significantly restored due to the effect of removing impurities by the electrode restoration treatment or the like in Examples 1 to 6. Meanwhile, the capacity retention rate was not significantly improved in Example 7 that is a comparative example in which only the electrolytic solution was replaced. Further, deterioration due to separation of the active material or the like occurred in the cleaning step in Example 8 that is a comparative example in which a coated electrode (containing binders or the like) was used.

### Example 9

### (1) Production of Positive Electrode

A honeycomb-type ceramic positive electrode was produced by the following procedure.

### (1a) Preparation of Forming Raw Material

Co₃O₄ powder (manufactured by SEIDO CHEMICAL INDUSTRY CO., LTD.) and Li₂CO₃ powder (manufactured by THE HONJO CHEMICAL CORPORATION) weighed to a molar ratio Li/Co of 1.01 were mixed, and thereafter the mixture was kept at 780° C. for 5 hours. The resultant powder was milled and crushed into a volume-based D50 of 0.4 μm with a pot mill to yield LiCoO₂ raw material powder. This LiCoO₂ raw material powder (100 parts by weight), a dispersive medium (toluene:isopropanol=1:1) (30 parts by weight), a binder (polyvinyl butyral: Product No. BM-2, manufactured by SEKISUI CHEMICAL CO., LTD.) (10 parts by weight), a plasticizer (DOP: Di(2-ethylhexyl)phthalate, manufactured by Kurogane Kasei Co., Ltd.) (4 parts by weight), and a dispersant (product name: RHEODOL SP-030, manufactured by Kao Corporation) (2 parts by weight) were mixed to yield a clayish forming raw material.

### (1b) Forming

The resulting forming raw material was extruded to obtain a honeycomb green body. The dimensions of the die were a honeycomb shape with a wall thickness of 100 μm and a pitch of 2.0 mm. The area of the die was about 20×20 mm. The resultant honeycomb green body was cut to a length of 50 mm.

### (1c) Firing

After raising the temperature to 600° C. at a temperature increase rate of 200° C./h and degreasing for 3 hours, the resultant honeycomb green body was placed in an alumina sheath (manufactured by Nikkato Corporation). In the closed sheath, the temperature was raised to 920° C. at 200° C./h and then kept for 4 hours. The resultant honeycomb structure was densely sintered to yield a honeycomb-type oriented ceramic positive electrode with a wall thickness of 100 μm and a pitch of 2.0 mm.

### (2) Production of Negative Electrodes

To 100 parts by weight of synthetic graphite (SCMG-CF manufactured by Showa Denko K.K.) and 10 parts by weight of PTFE (Polyflon D-1E manufactured by Daikin Industries, Ltd.), 30 parts by weight of isopropanol (manufactured by FUJIFILM Wako Pure Chemical Corporation) were added, and the mixture was kneaded and extruded through a die with dimensions of 1.9×1.9 mm to yield a rectangular-shaped negative electrode. By drying it under reduced pressure (−95 kPa, 80° C., 16 h) and cutting it into a length of 50 mm, rectangular-shaped negative electrodes were produced.

### (3) Production of Separator

Magnesium carbonate powder (manufactured by Konoshima Chemical Co., Ltd.) was heat-treated at 900° C. for 5 hours to obtain MgO powder. This powder (100 parts by weight), a dispersive medium (toluene:isopropanol=1:1) (100 parts by weight), a binder (polyvinyl butyral: Product No. BM-2, manufactured by SEKISUI CHEMICAL CO., LTD.) (20 parts by weight), a plasticizer (DOP: Di(2-ethylhexyl)phthalate, manufactured by Kurogane Kasei Co., Ltd.) (4 parts by weight), and a dispersant (product name: RHEODOL SP-O30, manufactured by Kao Corporation) (2 parts by weight) were mixed. With the resultant coating material, the aforementioned rectangular-shaped negative electrode was dip-coated up to 49 mm of the 50 mm in the length direction, and then vacuum-dried (−95 kPa, 100° C., 2 h) to form a separator film on the surface of the rectangular-shaped negative electrode.

### (4) Production of Conductive Adhesive

Acetylene black and polyimide amide were weighed to a mass ratio of 3:1 and mixed with an appropriate amount of NMP (N-methyl-2-pyrrolidone) as a solvent, to prepare a conductive carbon paste as a conductive adhesive.

### (5) Production of Battery

The rectangular-shaped negative electrode on which the MgO separator has been formed is inserted into each of the holes with a pitch of 2.0 mm formed in the above honeycomb-type ceramic positive electrode. The insertion into the honeycomb-type ceramic positive electrode is up to 49 mm where the separator is formed. Next, using the conductive adhesive produced, a copper foil with a thickness of 10 μm is attached to the end faces of the negative electrodes in the 1 mm portion protruding from the honeycomb structure. Also, to the end face of the honeycomb-type ceramic positive electrode where the negative electrodes did not protrude, a 15 μm aluminum foil was attached using the conductive adhesive. This structure was enclosed in a glass cell provided with current collecting sections, filled with an electrolytic solution, and closed to form a battery. The electrolytic solution used was obtained by dissolving LiPF₆ in an organic solvent of ethylene carbonate (EC) and ethyl methyl carbonate (EMC) mixed at a volume ratio of 3:7 to a concentration of 1.0 mol/L and further adding 2 parts by weight of vinylene carbonate as an additive.

(6) Measurement of Capacity Retention Rate after Storage

The capacity retention rate after storage of the battery was measured by the following procedure. First, the battery was charged at a constant voltage of 4.2 V in an environment of 25° C. and then discharged at a discharge rate of 0.2 C to measure the initial capacity. Then, a voltage of 4.2 V was applied in an environment of 50° C. and held for 50 days. Finally, the battery was charged at a constant voltage of 4.2 V and then discharged at 0.2 C to measure the capacity after storage. The measured capacity after storage was divided by the initial capacity and multiplied by 100 to obtain a capacity retention rate (%) after storage.

(7) Disassembly, Cleaning, and Reassembly of Battery after Storage

A battery discharged after storage was prepared, and the closed part of the glass cell was opened. The honeycomb structure was taken out from the glass cell. The rectangular-shaped negative electrodes inserted into the honeycomb-type ceramic positive electrode were pulled out, and the honeycomb-type ceramic positive electrode and the rectangular-shaped negative electrodes were separated. The honeycomb-type ceramic positive electrode taken out was immersed in an appropriate amount of NMP (N-methyl-2-pyrrolidone) and stirred for 20 minutes to detach the aluminum foil and conductive adhesive bonded to the positive electrode. The honeycomb-type ceramic positive electrode separated was again immersed in NMP and stirred for 60 minutes to dissolve and remove impurities such as the electrolytic solution decomposition product adhering to the honeycomb-type ceramic positive electrode. The same operation was repeated twice, and the honeycomb-type ceramic positive electrode from which impurities have been removed was vacuum-dried at 120° C. for 12 hours. The vacuum-dried honeycomb-type ceramic positive electrode was degreased by heating at 600° C. for 5 hours and then fired at 900° C. for 1 hour. The rectangular-shaped negative electrodes that had been pulled out were inserted into the fired honeycomb-type ceramic positive electrode, which was reassembled as a glass cell by the same procedure as described in (5) above (including replacement of the electrolytic solution).

### Example 10 (Comparison)

A reassembled battery was evaluated in the same manner as in Example 8, except that only the electrolytic solution was replaced without the electrode restoration treatment (cleaning and drying) after disassembling the battery in (7) above.

TABLE 2

| | Electrode restoration | Capacity | Capacity |
|---|---|---|---|
| | treatment | retention rate | retention rate |
| | (positive electrode | after storage | after reassembly |
| | regeneration treatment) | (%) | (%) |
| Ex. 9 | Done | 71 | 83 |
| Ex. 10* | None | 70 | 71 |

The symbol *indicates a comparative example.

What is claimed is:

1. A method for recycling a lithium-ion secondary battery, comprising:
providing a used lithium-ion secondary battery that comprises: (i) a battery element including a positive electrode, a separator, and a negative electrode, wherein at least one of the positive electrode and the negative electrode is a ceramic electrode; (ii) an electrolytic solution; and (iii) a battery container accommodating the battery element and the electrolytic solution;
taking out the ceramic electrode from the lithium-ion secondary battery so that the positive electrode and the negative electrode are separated from each other, provided that the separator may be bonded to the ceramic electrode taken out;
subjecting the ceramic electrode taken out to an electrode restoration treatment including cleaning and/or heat treatment; and
putting the ceramic electrode subjected to the electrode restoration treatment back into the battery container to assemble a lithium-ion secondary battery.

2. The method for recycling a lithium-ion secondary battery according to claim 1, wherein the electrode restoration treatment comprises cleaning the ceramic electrode with a polar solvent to remove impurities contained in and/or adhering to the ceramic electrode, followed by drying.

3. The method for recycling a lithium-ion secondary battery according to claim 1,
wherein the ceramic electrode further comprises a positive electrode current collector and/or a negative electrode current collector,
wherein the positive electrode current collector and/or the negative electrode current collector is detached before and/or during the cleaning, and
wherein the positive electrode current collector and/or the negative electrode current collector is attached to the ceramic electrode after the electrode restoration treatment.

4. The method for recycling a lithium-ion secondary battery according to claim 2, wherein the electrode restoration treatment comprises heating, at 300 to 1000° C., the ceramic electrode that have cleaned and dried.

5. The method for recycling a lithium-ion secondary battery according to claim 4, wherein the electrode restoration treatment comprises degreasing the ceramic electrode at 300 to 600° C. and/or firing the ceramic electrode at 650 to 1000° C.

6. The method for recycling a lithium-ion secondary battery according to claim 1, wherein the positive electrode is a ceramic positive electrode, and the ceramic positive electrode is composed of a lithium complex oxide sintered body.

7. The method for recycling a lithium-ion secondary battery according to claim 1, wherein the positive electrode is a ceramic positive electrode, and the ceramic positive electrode is an oriented positive electrode containing a plurality of primary grains composed of a lithium complex oxide, the plurality of primary grains being oriented at an average orientation angle of over 0° and 30° or less with respect to a principal plane of the positive electrode.

8. The method for recycling a lithium-ion secondary battery according to claim 6, wherein the lithium complex oxide is lithium cobaltate.

9. The method for recycling a lithium-ion secondary battery according to claim 1, wherein the negative electrode is a ceramic negative electrode, and the ceramic negative electrode is composed of a titanium-containing sintered body.

10. The method for recycling a lithium-ion secondary battery according to claim 9, wherein the titanium-containing sintered body contains lithium titanate or niobium titanium complex oxide.

11. The method for recycling a lithium-ion secondary battery according to claim 1, wherein the separator is a ceramic separator, and the ceramic separator comprises at least one selected from the group consisting of MgO, Al₂O₃, ZrO₂, SiC, Si₃N₄, AlN, and cordierite.

12. The method for recycling a lithium-ion secondary battery according to claim 1, further comprising replacing the electrolytic solution in the lithium-ion secondary battery with a fresh electrolytic solution.

13. The method for recycling a lithium-ion secondary battery according to claim 1, further comprising replacing the battery container with another battery container after the ceramic electrode is taken out and before the ceramic electrode is put back into the battery container.

14. The method for recycling a lithium-ion secondary battery according to claim 1, further comprising, when or before the lithium-ion secondary battery is assembled, replacing the positive electrode or negative electrode other than the ceramic electrode subjected to the electrode restoration treatment with a new or comparable positive electrode or negative electrode.
